(19) United States
(12) Patent Application Publication
(10) Pub. No.: US 2010/0106294 A1
(43) Pub. Date: Apr. 29, 2010

(54) Robot Control System and Control Method for Robot

(76) Inventors: Hisayoshi Sugihara, Aichi-ken (JP); Yutaka Nonomura, Aichi-ken (JP); Motohiro Fujiyoshi, Aichi-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/989,603

(22) PCT Filed: Aug. 1, 2006
(86) PCT No.: PCT/IB2006/002086

§ 371 Date: Jan. 29, 2008

(30) Foreign Application Priority Data
Aug. 1, 2005 (JP) 2005-223511

(51) Int. Cl. G06F 19/00

(52) U.S. Cl. 700/245

(57) ABSTRACT

During robot operation, a CPU (22) of a sensor unit (10) transmits the sensor output of a sensor (15) to a robot CPU (12) during a transmission period within a control period. During the remaining reception period within the control period, the robot CPU (22) transmits update parameters to the robot CPU (12). The CPU (22) receives these update parameters, and writes them in a second region, among the storage regions of a RAM (16), which is different from a first region in which the default parameters are set. And, upon further receipt of a update command from the robot CPU (22), the CPU (22) performs processing to change over the parameters from the default to the update parameters which have been stored in the second region.

### BACKGROUND OF THE INVENTION

1. Field of the Invention

The invention relates to a robot control system and a control method for a robot, and in particular to change of the function of a sensor unit.

2. Description of Related Art

Acceleration sensors and angular velocity sensors are used for attitude control of a mobile body of a robot or the like. If three orthogonal axes are set up, i.e., an X axis, a Y axis, and a Z axis, then the accelerations in these three axial directions are detected by three acceleration sensors, and the angular velocities around these three axes are detected by three angular velocity sensors. The angles around these axes, i.e., the attitude angles, are obtained by time integration of the outputs of the angular velocity sensors, and thereby a roll angle, a pitch angle, and a yaw angle are calculated.

In Japanese Patent Application Publication No. JP-A-2004-268730, a technique is disclosed for performing attitude control by using acceleration data and attitude data outputted from gyro sensors.

Furthermore, in Japanese Patent Application Publication No. JP-A-11-316732, a technique is described in which, as commands which are transmitted from a host to a peripheral processing device, there are provided an execution command which performs designation of an operation, and an execution command which does not perform designation of any operation, and it is made so that it is possible to change this operation, only at times when change of operation according to these two types of execution command is required.

When performing attitude control using acceleration data and/or attitude data, there is a requirement for accuracy of the attitude angles, but, since these attitude angles are obtained by time integration, sometimes it happens that the accuracy decreases due to integration of the errors. Thus, a requirement arises for resetting the attitude angles to 0°, or to predetermined angles, at some timing.

Furthermore, since the operational characteristics of the sensors are different according to the type of the robot whose attitude must be controlled, and according to the fitting positions or the fitting orientations of the sensors, there may be a requirement for adjusting the operational characteristics for each sensor individually. For example, it may be desirable to adjust the time constant of a filter to the most suitable value, or the like.

In order to respond to this type of request, it may be considered to stop the robot, and to again restart the operation of the robot after the characteristics of the sensor units have been changed; but it is desirable to be able to change the characteristics of the sensor units without delay during the operation of the robot. For example since, when the robot is performing some specific operation, only some specific sensor outputs are required among the plurality of sensor outputs which are being outputted from the sensor units, accordingly it would be desirable to be able to change the sensor units over directly to a characteristic in which only those sensor outputs are transmitted. Although in the above described Japanese Patent Application Publication No. JP-A-11-316732, it is possible to change over the operation as well, it is difficult to change over the operation in real time.

### DISCLOSURE OF THE INVENTION

It is an object of the invention to provide a robot control system and a control method for a robot, with which it is possible to change the characteristics (or the function) of a sensor unit which is installed in the robot immediately.

A robot control system according to a first aspect of the invention, comprises a main processor, and a sensor unit which transmits sensor output to the main processor. The sensor unit comprises a processor, and a memory which comprises a first region and a second region for storing parameters which stipulate the operation of the processor, and the processor, along with transmitting the sensor output to the main processor during a transmission period within a predetermined period by using the parameters which are stored in one of the first region or the second region of the memory, also receives update parameters from the main processor during the remainder of the reception period within the predetermined period, and stores them in the other one of the first region or the second region, and thereafter transmits the sensor output to the main processor using the update parameters.

With the robot control system of the first aspect, the sensor unit transmits the sensor output to the main processor of the robot based upon the parameters which are stored in either one of the first region or the second region of the memory (for example, suppose that it is the first region), but, when update parameters are received from the main processor in the reception period of the predetermined period, it stores these update parameters in the second region. And the processor of the sensor unit, instead of the parameters which are stored in the first region (the default parameters), operates based upon the update parameters which have thus been stored in the second region. By transmitting the update parameters from the main processor to the sensor unit during the reception period, even during the operation of the robot, and by storing the update parameters in a different region from the first region of the memory, and changing over the parameters from the default to the update parameters, it is possible to change the characteristics or the function of the sensor unit very quickly. When yet further update parameters are transmitted from the main processor during the operation of the update parameters which have been stored in the second region, these update parameters are stored, this time, in the first region. When these new update parameters have been stored, the sensor unit operates according to the new update parameters which have thus been stored in the first region, instead of according to the update parameters which have been stored in the second region. By thus using the first region and the second region of the memory in an alternating and complementary manner, it is possible to change the characteristics or the function of the sensor unit in real time as desired.

A control method according to a second aspect of the invention is for a robot comprises a main processor, and a sensor unit which transmits sensor output to the main processor. The sensor unit comprises a processor, and a memory which comprises a first region and a second region for storing parameters which stipulate the operation of the processor. The control method comprising: transmitting the sensor output to the main processor during a transmission period within a predetermined period by using the parameters which are stored in one of the first region or the second region of the memory; receiving update parameters from the main processor during the remainder of the reception period within the predetermined period, and storing the update parameters in the other one of the first region or the second region; and thereafter transmitting the sensor output to the main processor using the update parameters.

According to the invention, it is possible to change the characteristics (or the function) of a sensor unit which is installed in the robot immediately.

### BRIEF DESCRIPTION OF THE DRAWINGS

The foregoing and further objects, features and advantages of the invention will become apparent from the following description of example embodiments with reference to the accompanying drawings, wherein the same or corresponding portion are denoted by the same reference numerals and wherein:

FIG. 1 is a conceptual structural diagram of a robot control system according to an embodiment of the invention;

FIGS. 2A and 2B are a timing chart for data transmission and reception;

FIG. 3 is an explanatory figure showing data received by a CPU 22;

FIG. 4 is a first explanatory figure for the operation of a sensor unit;

FIG. 5 is a second explanatory figure for the operation of the sensor unit;

FIG. 6 is a third explanatory figure for the operation of the sensor unit;

FIG. 7 is a fourth explanatory figure for the operation of the sensor unit;

FIG. 8 is a fifth explanatory figure for the operation of the sensor unit; and

FIG. 9 is a sixth explanatory figure for the operation of the sensor unit.

### DETAILED DESCRIPTION OF THE PREFERRED EMBODIMENTS

In the following, an embodiment of the invention will be explained with reference to the drawings.

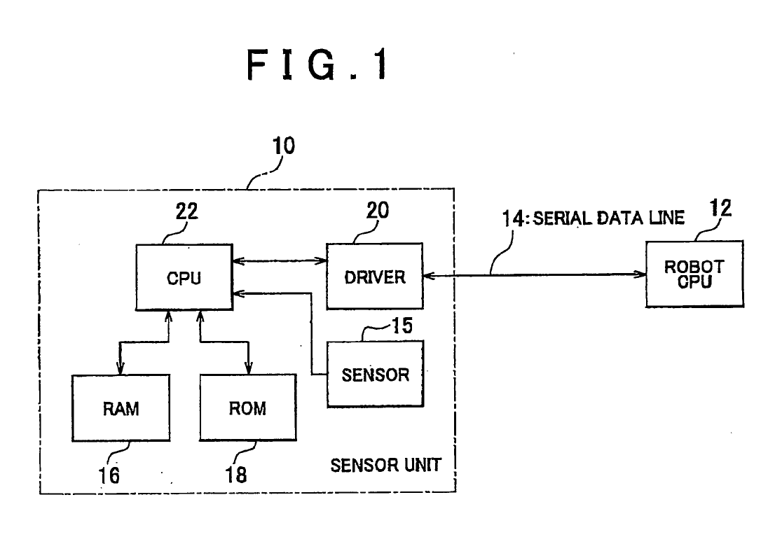

FIG. 1 is a conceptual structural diagram of a robot control system according to an embodiment of the invention. A sensor unit 10 and a robot CPU 12, which is a main processor of a robot, are provided, and this sensor unit 10 and robot CPU 12 are connected together by a serial data line 14, so as to be capable of serial communication with one another. It should be understood that the robot to which this sensor unit 10 and robot CPU 12 are installed may be of any desired type; it may be any of a robot which runs upon two wheels, a robot which runs upon four wheels, a robot which walks upon two legs, a flying robot, or the like.

The sensor unit 10 comprises a sensor 15 which is an acceleration sensor or an angular velocity sensor or the like, a RAM 16, a ROM 18, a driver 20, and a CPU 22.

The ROM 18 stores an OS (operating system) or a program in which is written execution processing for the sensor unit 10. In this program, there are included parameters which change over the type of the sensor output to be transmitted to the robot CPU 12 or a reset function, or which set the time constant of an internal filter or the like. The ROM 18 is a non-volatile memory which can be rewritten, such as a flash ROM or the like.

The RAM 16 stores parameters which have been stored in the ROM 18. In other words, during boot operation when the power supply is turned on, the parameters which are stored in the ROM 18 are read out and are written (i.e., are loaded) into the RAM 16, and predetermined processing is then performed by reading out the parameters which are written in the RAM 16. The CPU 22 writes these parameters which have been read out from the ROM 18 in a specified region of the RAM 16. In this embodiment, this specified region is termed the “first region”. For this first region, its start address (physical address) and its end address may be fixedly set in advance within the RAM 16; or, alternatively, they may be alterable.

According to the parameters which have been read out from the RAM 16, the CPU 22 selects, from among the various types of sensor output which have been inputted from the sensor 15, those of the sensor outputs which are set by the parameters, and transmits them to the robot CPU 12 via the driver 20. The driver 20 may be, for example, a RS-232C driver, but it is not limited thereto; it may alternatively be USB, RS422, IEEE1394, or the like. The CPU 22 transmits the sensor output data out to the serial line via the driver 20, but transmits this data only during a transmission period, which is a portion of a predetermined control period. The remainder of the predetermined control period is allocated as a reception period, during which the CPU 22 receives data which has been transmitted from the robot CPU 12 via the serial data line 14.

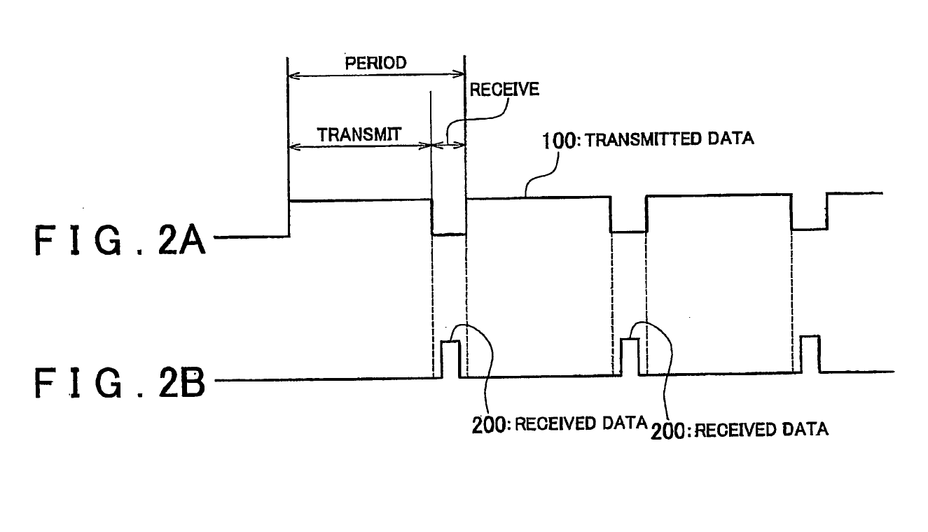

FIGS. 2A and 2B are a timing chart showing the serial communication which is performed between the CPU 22 of the sensor unit 10 and the CPU 12 of the robot. FIG. 2A is a timing chart during data transmission as seen from the CPU 22, while FIG. 2B is a timing chart during data reception as seen from the CPU 22.

In FIG. 2A, one control period is, for example, 10 msec, and this control period is time divided into a transmission period and a reception period. The CPU 22 transmits the sensor output from the sensor 15 serially to the robot CPU 12 during this transmission period. The transmitted data format includes a transmission pattern and measurement data: the transmission pattern sets which sensor output is transmitted, while the actual sensor output from the sensor 15 is transmitted in the measurement data. The transmission pattern is specified as being 16 bits, and, for example, each bit may be set as below:
Least significant bit (LSB): attitude angle (roll angle, pitch angle, yaw angle)
Bit 1: angular velocity
Bit 2: acceleration
Bit 3: tilt angle
Bit 4: acceleration after gravity compensation
Bit 5: speed
Bit 6: position
Bit 7: attitude matrix
Bit 8: attitude matrix
Bit 9: attitude matrix
Bit 10: attitude matrix
Bit 11: not used
Bit 12: unit temperature
Bit 13: substrate temperature
Bit 14: diagnosis
Bit 15: time count
When any one of these bits is “1”, data corresponding thereto is transmitted as the measurement data. For example, when bit 0 (LSB) is “1”, the attitude angle data from the sensor 15 is transmitted as the measurement data. The robot CPU 12 distinguishes what data to transmit from the CPU 22 by decoding this transmitted pattern. In the figure, the data which has been transmitted from the CPU 22 during the transmission period is shown as being the transmitted data 100.

On the other hand, as shown in FIG. 2B, the remaining portion of the control period other than the transmission period is allocated as the reception period, and the robot CPU 12 transmits data to the serial data line 14 at this timing. And the CPU 22 receives the data which has been transmitted from the robot CPU 12 at this timing. In the figure, the data which has been transmitted from the robot CPU 12 is shown as being the received data 200. When the CPU 22 receives data from the robot CPU 12 during this reception period, it stores this received data 200 in the RAM 16. The region in which the received data 200 is stored is a second region, which is different from the first region. The start address of the second region may be the next address after the end address of the first region, or may be separated therefrom by just a predetermined number of storage addresses. If the amount of data to be transmitted is large, then the robot CPU 12 may divide this data into packets over a plurality of control periods, and may transmit them in series. The CPU 22 receives this data in series, and stores it in the second region of the RAM 16. The data which is transmitted from the robot CPU 12 is update parameters and control commands for the sensor unit 10.

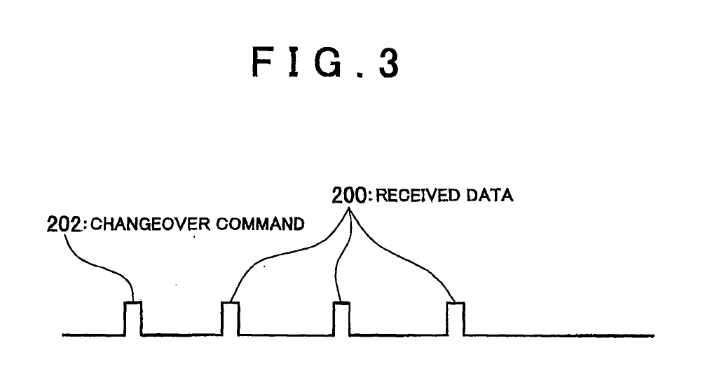

FIG. 3 shows a series of data which is transmitted in order in the reception period of the control period from the robot CPU 12 to the CPU 22. The robot CPU 12 transmits a changeover command 202 at the timing at which the parameters of the sensor unit 10 are to be updated. Upon receipt of this changeover command 202, the CPU 22 sets the start address position for writing into the RAM 16 to the start address of the second region. And it proceeds to write the data 200 received from the robot CPU 12 in order into the second region of the RAM 16. When the CPU 22 has received all of the received data 200 and has finished writing it into the RAM 16, it changes over the address for reading out from the RAM 16 from the first region to the second region, and executes the data which is stored in the second region as new parameters. One example of a changeover command is the “SET” command, and, after the SET command, the robot CPU 12 sets the number of data (the setting location) and the update parameters and transmits them to the sensor unit 10. The CPU 22 of the sensor unit 10 interprets the “SET” command, and stores the update parameters in the second region of the RAM 16.

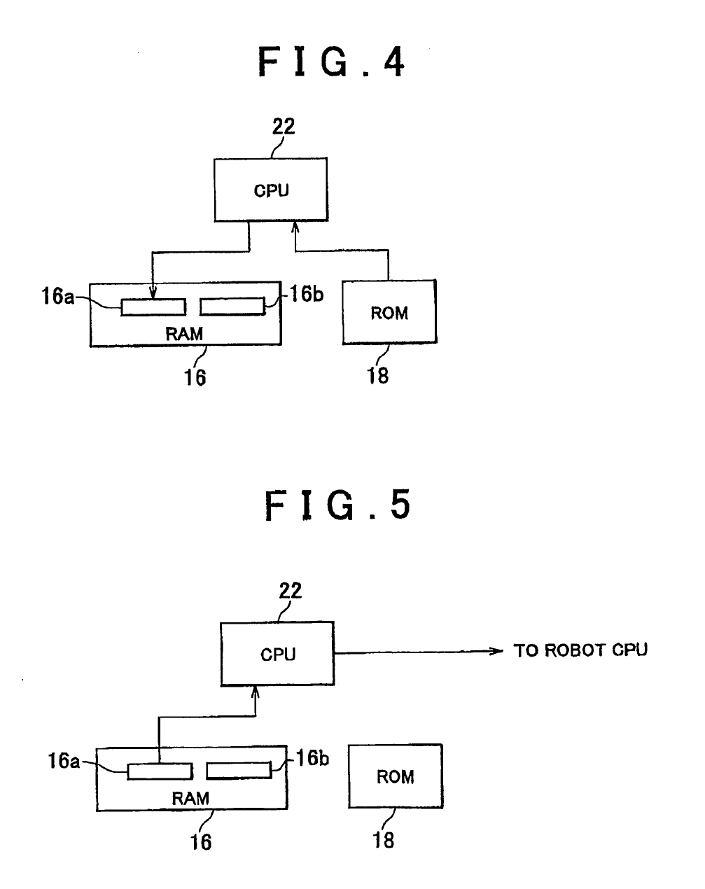

The time series of the operation of the sensor unit 10 is shown in FIGS. 4 through 9. FIG. 4 is the operation when the power supply is turned ON. The CPU 22 reads out the default parameters which are stored in the ROM 18, and loads them into the first region 16a of the RAM 16.

FIG. 5 is the processing during operation. The CPU 22 transmits the sensor output from the sensor 15 to the robot CPU 12 according to the parameters which are stored in the first region 16a of the RAM 16. If the default parameters are that the least significant bit, the first bit, and the second bit of the transmitted pattern are all “1”, then, according to these parameters, the CPU 22 transmits the attitude angle data, the angular velocity data, and the acceleration data to the robot CPU 12 from the sensor 15.

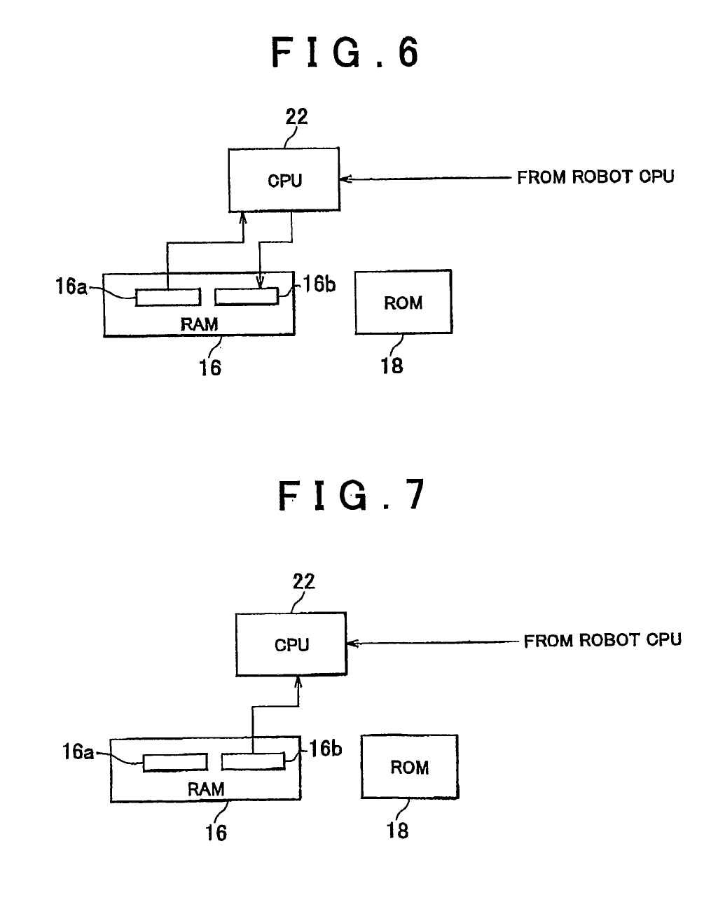

FIG. 6 is the processing during parameter updating. The CPU 22 transmits the sensor output according to the default parameters which have been stored in the first region 16a of the RAM 16 as described above, but when, in the reception period of the control period, a changeover command 202 is received from the robot CPU 12, then the received data which follows it is written into the second region 16b of the RAM 16. During this writing of the received data into the second region 16b, the transmission of data to the robot CPU 12 is performed according to the default parameters. To show the transmission parameters by the least significant bit, the first bit, and the second bit by way of example, the transmission parameters (the default parameters) of “111” are stored in the first region 16a of the RAM 16, and the transmission parameters (the update parameters) of “100” are stored in the second region 16b of the RAM 16.

FIG. 7 is the processing after the updating of the parameters has been completed. The CPU 22 changes over the region for reading out the RAM 16 from the first region 16a to the second region 16b, and performs processing according to the update parameters which are stored in the second region 16b. If the update parameters are “100” as described above, from the next control period, the CPU 22 transmits the acceleration data to the robot CPU 12, but does not transmit the attitude angle data and the angular velocity data. Furthermore, if the details of the update are to reset the attitude angle, then the robot CPU 12 sets the reset value as the received data 200, and transmits a reset command as an update command 204. According to this reset command, the CPU 22 reads out the reset value from the second region 16b of the RAM 16, and resets the sensor 15.

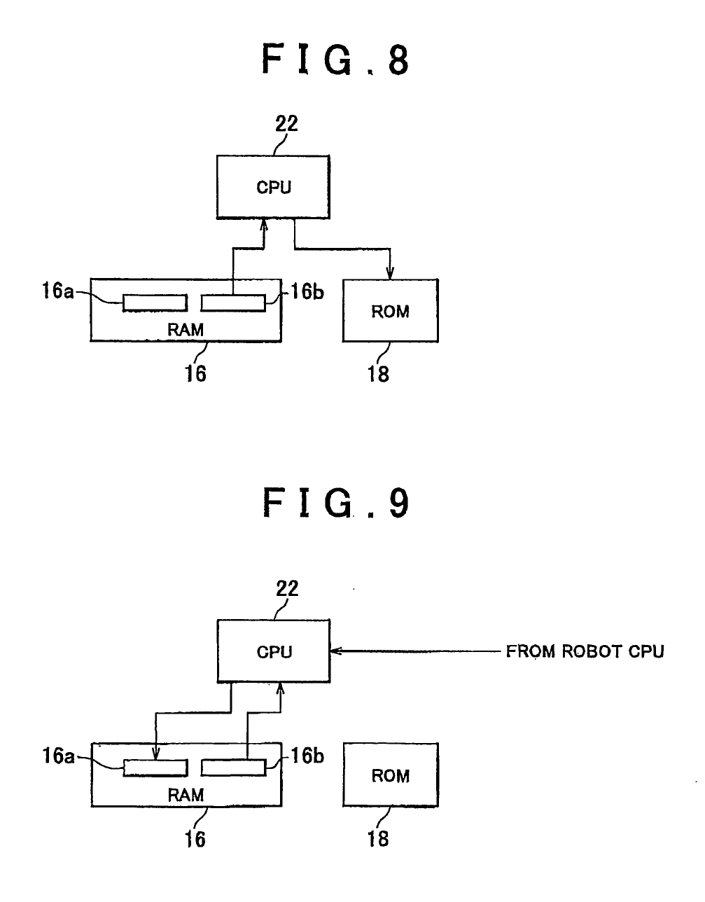

FIG. 8 is the operation when the power supply is turned OFF. The CPU 22 writes the update parameters which have been stored in the second region 16b of the RAM 16 into the ROM 18. The next time that the power supply is turned ON, as shown in FIG. 4, the updated parameters which have been stored in the ROM 18 are read out as the default parameters, and are loaded into the first region 16a of the RAM 16.

On the other hand, during performing of processing according to the update parameters which have been stored in the second region as shown in FIG. 7, sometimes it may happen that other update parameters are also transmitted from the robot CPU 12. The processing in this case is shown in FIG. 9. The CPU 22 performs processing according to the update parameters which have been stored in the second region 16b. When, at this time, a new changeover command and update parameters are received in the reception period, these new update parameters are now stored in the first region 16a in order. And, after all of the update parameters have been stored in the first region 16a, the CPU 22 changes over the region for reading out from the RAM 16 from the second region 16b to the first region 16a again, and performs processing according to the update parameters which have been stored in the first region 16a. By using the first region 16a and the second region 16b in an alternating manner like this, it is possible to change over the parameters at any time, even during operation of the sensor unit 10. If the region in the RAM 16 in which the parameters which are to be used for operation are stored is termed the active region, then, at some timing, while the first region 16a is the active region and the second region 16b is the inactive region, the update parameters are stored in the inactive region; and, after the arrangements for storing all of the update parameters have been completed, the second region 16b is changed over to being the active region, while the first region 16a is changed over to being the inactive region; and subsequently the same processing is repeated. The changeover between the active region and the inactive region is directly after all of the update parameters which are required for operation have been stored, and data transmission according to the update parameters is performed from a directly subsequent transmission timing. It should be understood that if it is not possible to allocate the job during calculation processing by the CPU 22, or if, during communication by RS-232C or the like, no surplus time is available, then data transmission according to the update parameters is performed from the subsequent transmission frame. Although the inactive region is kept in the inactive state provided than no new update parameters are transmitted from the robot CPU 12, it would also be acceptable to arrange to use the parameters which are stored in the active region by copying them to this region as a preparatory region.

As explained above, with this embodiment, even while the robot is operating, it is possible for the robot CPU 12 to transmit the update parameters and update command to the sensor unit 10 during the reception period within the control period, and it is possible for the sensor unit 10 to store the update parameters in a different region of the

RAM 16, and to perform processing to changeover from the default parameters to the update parameters upon triggering by receipt of an update command; and it is accordingly possible to change the characteristics or the function of the sensor unit 10 quickly, and moreover in a simple and easy manner.

When such change is performed repeatedly, in order to maintain the history of previous changes of the parameters, after having changed over the operation region of the main processor to the new active region, the contents thereof are immediately copied to the inactive region. The history of the changes to the parameters is maintained due to the fact that the next change of parameters is added onto and written into the inactive region which has been copied. Here, it is not necessary for all of the data in the active region to be copied to the inactive region; it is desirable to shorten the time required for the operation by copying only that portion which has changed, since the same beneficial effect can be obtained.

It should be understood that, for robot control or the like, it is necessary that the calculation speed interior to the sensor should be extremely fast, and that the calculation should be performed accurately with respect to time. When, for example, calculating the angle from the angular velocity, the angle is obtained by integrating the output from the angular velocity sensor, but this must be performed accurately in the series n, n+1, n+2, with the integration period At for processing discrete data being accurate. On the other hand, the communication to receive output of the sensor data and changes of settings takes a considerable amount of time, and moreover fluctuates according to the contents of the data and the communication environment. Accordingly when, simultaneously with receipt of the parameter settings from the main processor, the details of the calculation processing on the sensor side change, then the calculation period and the calculation timing become disturbed, and the accuracy of the data is lost. For example, At may no longer be constant, or an omission may occur in the data processing steps like n, n+1, n+3, . . . . But since, according to the invention, it is possible to determine the timing of actual operation according to the change of parameters by a timing interior to the sensor, accordingly it is possible to keep the calculation period and the calculation timing constant. Furthermore, although it is necessary to pause the calculation during change of the parameters since the parameters are not definite, with the method according to the invention, until the change of the parameters is definite, the interior calculation is performed using the parameters in the first region 16a established directly previously, and the parameters during the change are written into the second region 16b. Since, by using the second region 16b in which the changed parameters have been set up in the next calculation timing, it is made possible to perform the calculation continuously while preventing delay or standstill in the calculation time, accordingly it is possible to obtain a sensor output suitable for real time control.

The invention is not to be considered as being limited to the embodiment described above; there are various alternative possibilities. For example although, with this embodiment, in consideration of the amount of data in the update parameters, the update parameters were divided into packets, and these packets were transmitted over a plurality of control periods, it would also be acceptable to arranged to transmit the update parameters during the reception period within a single control period.

Furthermore, although in this embodiment, as shown in FIG. 3, changeover commands 202 are transmitted before and after the update parameters (the contents of the received data 200 is the update parameters), it would also be acceptable not to transmit any changeover command 202. If data which has been transmitted from the robot CPU 12 is present during the reception period, the CPU 22 changes over the parameters from the default to the update parameters by writing the data into the second region 16b of the RAM 16.

Moreover, although in this embodiment, as shown in FIG. 8, when the power supply is turned OFF, the update parameters which have been stored in the second region 16b of the RAM 16 are written into the ROM 18, it would also be acceptable to write the update parameters into the ROM 18 when a write command which has been transmitted from the robot CPU 12 has been received.

With the robot control system of this embodiment, it is possible to implement the characteristics or the functions of the sensor unit 10 almost in real time. If resetting of the attitude angle is to be executed periodically, or during robot stopping operation, then the robot CPU 12 transmits a reset command during the reception period of the control period periodically, or during robot stopping operation. The CPU 22 receives this reset command, and resets the attitude angle output of the sensor 15 to zero. An automatic compensation function during robot stopping operation is provided to the sensor unit 10, and, when setting with the parameters whether this function is to be effective or is to be ineffective, the robot CPU 12 transmits the update parameters according to a command from the user. The CPU 22 changes over the default parameters (functionally ineffective) to the update parameters (functionally effective), and subsequently, each time it detects stopping of the robot, it automatically performs zero point output compensation or the like for the robot.

1. A robot control system including a main processor for a robot, and a sensor unit which transmits sensor output to the main processor, characterized in:
that the sensor unit comprises:
a processor; and
a memory which comprises a first region and a second region for storing parameters which stipulate the operation of the processor, and
that the processor, along with transmitting the sensor output to the main processor during a transmission period within a predetermined period by using the parameters which are stored in one of the first region and the second region of the memory, also receives update parameters from the main processor during the remainder of the reception period within the predetermined period, and stores the update paramenters in the other one of the first region and the second region, and thereafter transmits the sensor output to the main processor using the update parameters.

2. The robot control system according to claim 1, wherein the processor receives packets of the update parameters in sequence over a plurality of the predetermined periods, and stores them in sequence in the memory.

3. The robot control system according to claim 1, wherein the processor stores the update parameters which are stored in the memory in non-volatile memory, and, upon the next boot, reads out the update parameters and stores them in the memory.

4. The robot control system according to claim 1, wherein the main processor transmits a changeover command before the transmission of the update parameters to the sensor unit.

5. The robot control system according to claim 1, the processor transmits the sensor output by using the parameters which are stored in the one of the first region or the second region of the memory during a strage process of the update parameters.

6. The robot control system according to claim 1, wherein the processor changes over a region for reading out of the sensor output to be transmitted to the main processor to the other one of the first region and the second region after a strage process of the update paramenters is completed.

7. The robot control system according to claim 6, when the update parameters are copied to the one of the first region and the second region when the processor changes over the region for reading out of the sensor output.

8. The robot control system according to claim 1, wherein the processor stores the update parameters in the non-volatile memory when power supply is turned off.

9. A control method for a robot including a main processor for a robot, and a sensor unit which transmits sensor output to the main processor, wherein the sensor comprises a processor, and a memory which comprises a first region and a second region for storing parameters which stipulate the operation of the processor, the control method characterized by comprising:
transmitting the sensor output to the main processor during a transmission period within a predetermined period by using the parameters which are stored in one of the first region and the second region of the memory;
receiving update parameters from the main processor during the remainder of the reception period within the predetermined period, and storing the update paramenters in the other one of the first region and the second region; and
transmitting the sensor output to the main processor using the update parameters after storing the update parameters.
